(19) United States
(12) Patent Application Publication
(10) Pub. No.: US 2020/0218579 A1
(43) Pub. Date: Jul. 9, 2020

(54) SELECTING A CLOUD SERVICE PROVIDER

(71) Applicant: Hewlett Packard Enterprise Development LP, Houston, TX (US)

(72) Inventors: Vikas D M, Bangalore (IN); Lokesh S, Bangalore (IN)

(21) Appl. No.: 16/242,322

(22) Filed: Jan. 8, 2019

(51) Int. Cl. G06F 9/50; H04L 12/24; G06F 16/2457; H04L 29/08

(52) U.S. Cl. CPC G06F 9/5072; H04L 41/5054; G06F 2209/508; H04L 67/34; G06F 2209/5015; G06F 16/24578

(57) ABSTRACT

Example implementations relate to selecting a cloud service provider. A computing device may comprise a processing resource and a memory resource storing non-transitory machine-readable instructions to cause the processing resource to select a cloud service provider from a group of cloud service providers to provide a service for a workload based on a received deployment preference for the workload, and a service characteristic of the cloud service provider, deploy the workload to the selected cloud service provider.

### BACKGROUND

Cloud computing can provide pools of computing resources and/or other services which may be provisioned. For example, a particular workload may be deployed utilizing pooled computing resources in a cloud computing environment. Various cloud service providers can provide pools of computing resources and/or other services for users to utilize to, for example, deploy a workload.

### BRIEF DESCRIPTION OF THE DRAWINGS

FIG. 1 illustrates an example system consistent with the disclosure.

FIG. 2 illustrates an example method consistent with the disclosure.

FIG. 3 is a block diagram of an example computing device for selecting a cloud service provider consistent with the disclosure.

FIG. 4 is a block diagram of an example system consistent with the disclosure.

FIG. 5 illustrates an example method consistent with the disclosure.

### DETAILED DESCRIPTION

Cloud service providers can offer various services for users. For example, cloud service providers computing resources and/or other services for use. As used herein, the term “cloud service provider” can, for example, refer to a provider of cloud services. As used herein, the term “cloud services” can, for example, refer to shared pools of attributable computer system resources and services. Users of cloud services may utilize cloud computing resources to perform various computing tasks, allowing for users to avoid or lessen computing infrastructure and maintenance costs, among other reasons.

There may be different cloud service providers which can offer different types of computing resources and/or services. For example, cloud services may be offered across public cloud services, private cloud services, and/or hybrid cloud services (e.g., a cloud service which can offer specific cloud service providers or all cloud service providers).

Selecting a cloud service provider, according to the disclosure, can allow for selection of a cloud service provider from a group of cloud service providers to provide a service for a workload. For example, a cloud service provider can be selected to deploy a workload. Selection of the cloud service provider can be based on a deployment preference of the user for the workload and a service characteristic of the cloud service provider. Accordingly, a cloud service provider can be selected for a particular workload that can suit deployment of the particular workload, allowing for efficient user of cloud service providers to deploy the particular workload.

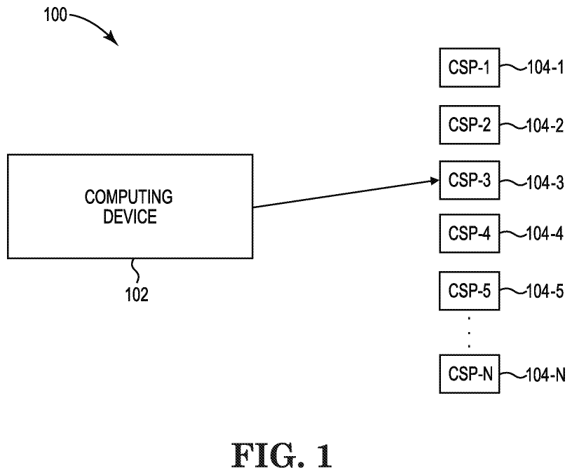

FIG. 1 illustrates an example system 100 consistent with the disclosure. As illustrated in FIG. 1, the system 100 can include computing device 102 and cloud service providers 104-1, 104-2, 104-3, 104-4, 104-5, 104-N (referred to collectively herein as cloud service providers 104).

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized for selecting a cloud service provider. For example, computing device 102 can be utilized to select a cloud service provider from a group of cloud service providers 104 to provide a service for a workload, as is further described herein. As described above, a user may desire to execute a workload utilizing cloud computing resources. Computing device 102 can select a cloud service provider from the group of cloud service providers 104 to provide a service, such as executing the workload. As used herein, the term “workload” can, for example, refer to a set of instructions that are executed by a processor to perform a task. For example, the workload can be a set of non-transitory machine-readable instructions that are executed by a processor to perform a coordinated function, task, and/or activity, as is further described herein.

Computing device 102 can receive a deployment preference for a workload to be deployed by a cloud service provider 104. As used herein, the term “deployment preference” can, for example, refer to a prioritized consideration for deployment of a workload on a cloud service provider. For example, a deployment preference can be, for example, a prioritized consideration which may include a success rate of previous workloads deployed on a particular cloud service provider 104, cost to deploy the workload on a particular cloud service provider 104, availability of the cloud service provider 104, network quality of service (QOS) parameters of a particular cloud service provider 104, user ratings of a particular cloud service provider 104, and/or cluster orchestration of a particular cloud service provider 104, among other types of considerations for workload deployment. Deployment preferences can be preferences of a user for deployment of a workload on a particular cloud service provider 104. The deployment preferences can be preferences which correlate to service characteristics of a particular cloud service provider 104, as is further described herein.

In some examples, computing device 102 can receive ranked deployment preferences for the workload. For example, a user may rank particular deployment preferences in order of importance to the user. For instance, a user may consider cost to deploy a workload, a success rate of previously deployed workloads, and cluster orchestration of the cloud service provider 104 to be relevant and can, for instance, rank those deployment preferences in that order. That is, the user may rank cost of deployment as most relevant, success rate of previous workloads as second most relevant, cluster orchestration as third most relevant, etc. In other words, a user can filter cloud service providers 104 based on service characteristics of the cloud service providers 104 using deployment preferences, as is further described herein.

Computing device 102 can select a cloud service provider from the group of cloud service providers 104 based on the received deployment preference for the workload and service characteristics of the cloud service providers 104. As described above, cloud service providers can provide cloud services, such as attributable computer system resources and services to perform various computing tasks. Cloud service providers 104 can include public cloud services, private cloud services, and/or hybrid cloud services. As used herein, the term “public cloud” refers to computing services offered over public Internet. As used herein, the term “private cloud” refers to computing services offered over private information technology (IT) infrastructure. As used herein, the term “hybrid cloud” refers to computing services that utilize a mix of private cloud and public cloud services. As described herein, cloud service providers 104-1, 104-2, 104-3, 104-4, 104-5, and/or 104-N can be public cloud service providers, private cloud service providers, hybrid cloud service providers, and/or a combination thereof. Services of the cloud service providers 104 can include virtual machine (VM) images, container images and charts, and/or VM templates, among other types of services, as is further described herein.

In some examples, cloud service providers 104 can offer services including VM images. As used herein, the term “VM” refers to an emulation of a physical computing device. As used herein, the term “VM image” can, for example, refer to an execution state and memory pages of a VM. For example, VM images can be deployed on a cloud service provider 104.

In some examples, cloud service providers 104 can offer services including container images and charts. As used herein, the term “container” refers to software that includes machine-readable instructions and all dependencies of the machine-readable instructions. As used herein, the term “charts” refers to a collection of files that describe a related set of cloud computing resources.

In some examples, cloud service providers 104 can offer services including VM templates. As used herein, the term “VM template” refers to a master copy of a VM that can be used to create clones of VMs.

Computing device 102 can select a cloud service provider from the group of cloud service providers 104 to provide a service for a workload based on the service characteristic of the selected cloud service provider corresponding to the received deployment preference having a highest rank among a plurality of service characteristics of the group of cloud service providers 104. As used herein, the term “service characteristic” can, for example, refer to a distinguishing feature or quality. As described above, service characteristics can correlate to deployment preferences of a user for a particular workload. Service characteristics can describe features or qualities of a particular cloud service provider 104.

For example, service characteristics of a cloud service provider 104 can include a success rate of deployment of previous workloads of the cloud service provider 104, cost to deploy the workload using the cloud service provider 104, availability of the cloud service provider 104, network quality of service parameters of the cloud service provider 104, user ratings of the cloud service provider 104, and/or cluster orchestration of the cloud service provider 104, among other service characteristics of a cloud service provider 104.

Service characteristics of the cloud service providers 104 can include a success rate of previous workloads. As used herein, the term “success rate” refers to an amount of successful deployments of workloads in relation to a total number of deployments of workloads. The success rate of previous workloads can be an amount of successful workloads that are the same or similar to the desired workload to be deployed by the user. As an example, cloud service provider 104-1 can have a deployment success rate of 99.5%, cloud service provider 104-2 can have a deployment success rate of 99.3%, cloud service provider 104-3 can have a deployment success rate of 98.9%, and cloud service provider 104-4 can have a deployment success rate of 97.5%. Computing device 102 can receive a success rate deployment preference for the workload and select cloud service provider 104-1 based on cloud service provider 104-1 having a 99.5% successful deployment rate (e.g., having the highest ranked success rate deployment preference of the group of cloud service providers 104) among the success rates of the rest of the group of cloud service providers 104.

Service characteristics of cloud service providers 104 can include a cost to deploy the workload. Cost can be based on cloud service parameters, which can be selected by a user. As used herein, the term “cloud service parameters” can, for example, refer to a hardware characteristic of a cloud service provider. For example, hardware characteristics of a cloud service provider 104 can include an amount of computer processing unit (CPU) speed (e.g., in Hertz (Hz)), an amount of available memory, an amount of processing cores, an amount of hard disk drive (HDD) space, and/or any other hardware characteristics.

Computing device 102 can receive a cost deployment preference. As an example, cloud service provider 104-1 can have a deployment cost of $1000, cloud service provider 104-2 can have a deployment cost of $1100, cloud service provider 104-3 can have a deployment cost of $1700, and cloud service provider 104-4 can have a deployment cost of $2000. Computing device 102 can receive a cost deployment preference for the workload to be the cheapest cost available and select cloud service provider 104-1 based on cloud service provider 104-1 having the lowest cost to deploy the workload (e.g., $1000) among the costs of the rest of the group of cloud service providers 104.

In some examples, a user can select desired cloud service parameters. For instance, a user can specify a desired CPU speed, memory, processing cores, and/or HDD space for a particular workload, among other types of cloud service parameters. For example, a user can specify cloud service parameters of six GB of memory and two terabytes (TB) of HDD space as deployment preferences to deploy a particular workload. Computing device 102 can receive the deployment preferences of six GB of memory and two TB of HDD space and select cloud service provider 104-2 based on cloud service provider 104-2 having the requested cloud service parameters (e.g., six GB of memory and two TB of HDD space).

As described above, in some examples, cost can refer to a monetary cost. For example, the monetary cost may correlate with selected cloud service providers. Continuing with the example from above, a user may specify cloud service parameters of six GB of memory and two TB of HDD space as preferences to deploy a particular workload, as well as specify a maximum cost the user is willing to pay to deploy the workload. Computing device 102 can determine that, based on the cloud service parameters of six GB of memory and two TB of HDD space, the cost to deploy the workload on cloud service provider 104-1 would exceed the maximum cost specified by the user, but the cost to deploy the workload on cloud service provider 104-2 does not exceed the maximum cost specified by the user, and as such, computing device 102 can select cloud service provider 104-2 to provide a service for the workload.

Service characteristics of the cloud service providers 104 can include an availability of the cloud service provider. As used herein, the term “availability” refers to an amount of time the cloud service provider is available to provide a service for a workload. As an example, cloud service provider 104-1 can have a high availability of 99.99%, cloud service provider 104-2 can have a high availability of 99.9%, cloud service provider 104-3 can have a high availability of 99.5%, and cloud service provider 104-4 can have a high availability of 0%. Computing device 102 can receive a high availability deployment preference and select cloud service provider 104-3 based on cloud service provider 104-3 having the highest ranked percentage of high availability (e.g., 99.5%) among the high availability percentages of the rest of the group of cloud service providers 104.

Service characteristics of the cloud service providers 104 can include network QOS parameters of the cloud service provider. As used herein, the term “network QOS parameters” refers to accessibility characteristics of the cloud service provider. For example, network QOS parameters can include time to access, delay, and/or other network QOS parameters. As an example, cloud service provider 104-1 can have an average time to access of 25 seconds, cloud service provider 104-2 can have an average time to access of 30 seconds, cloud service provider 104-3 can have an average time to access of 45 seconds, and cloud service provider 104-4 can have an average time to access of 60 seconds. Computing device 102 can receive an average time to access deployment preference for the workload and select cloud service provider 104-1 based on cloud service provider 104-1 having the lowest average time to access (e.g., 25 seconds) among the average time to access of the rest of the group of cloud service providers 104.

Service characteristics of the cloud service providers 104 can include user ratings of the cloud service provider. As used herein, the term “user rating” refers to a classification according to user experiences. For example, users who have used a cloud service provider 104 in the past can rate the cloud service provider 104 based on their experience. As an example, cloud service provider 104-1 can have a user rating of 4.8 (out of 5), cloud service provider 104-2 can have a user rating of 4.5 (out of 5), cloud service provider 104-3 can have a user rating of 4.4 (out of 5), and cloud service provider 104-4 can have a user rating of 3 (out of 5). Computing device 102 can receive a user rating deployment preference for the workload and select cloud service provider 104-2 based on cloud service provider 104-2 having the highest user rating (e.g., 4.5) among the user ratings of the rest of the group of cloud service providers 104.

Service characteristics of the cloud service providers 104 can include cluster orchestration of the cloud service provider. As used herein, the term “cluster orchestration” refers to an organization of a cloud service cluster. For example, a cloud service provider can have differently organized clusters, and/or different cluster orchestration tools. As an example, cloud service provider 104-1 can utilize Ansible playbooks as cluster orchestration tools, cloud service provider 104-2 can utilize Ansible playbooks as cluster orchestration tools, cloud service provider 104-3 can utilize Terraform templates as cluster orchestration tools, and cloud service provider 104-4 can utilize Terraform templates as cluster orchestration tools. Computing device 102 can receive a cluster orchestration deployment preference and select cloud service provider 104-3 or cloud service provider 104-4 based on cloud service providers 104-3 and 104-4 having Terraform templates as cluster orchestration tools. In the example described above, computing device 102 can select either cloud service provider 104-3 or 104-4 randomly or can utilize another service characteristic described above to choose either cloud service provider 104-3 or 104-4.

As previously described above, computing device 102 can receive ranked deployment preferences for the workload. For example, a user may consider cluster orchestration and success rate of previously deployed workloads, in order of importance. For instance, cloud service provider 104-3 and cloud service provider 104-4 may both utilize Terraform templates as cluster orchestration tools. Accordingly, computing device 102 can select cloud service provider 104-3, as cloud service provider 104-3 includes a success rate of previously deployed workloads of 98.9%, which is higher than the success rate of previously deployed workloads of cloud service provider 104-4 (e.g., 97.5%).

Although described above as selecting cloud service providers based on ranked deployment preferences including cluster orchestration and success rate, examples of the disclosure are not so limited. For example, computing device 102 can select cloud service providers based on any other ranked deployment preferences.

In some examples, a specific deployment preference may be received from a user. For example, computing device 102 may receive a specific deployment preference of a user rating of 5 out of 5. In some examples, the specific deployment preference received from the user may not exactly match a service characteristic of a cloud service provider 104. That is, the user rating deployment preference of 5 out of 5 may not exactly match any of the user ratings of the cloud service providers 104. In such an example, computing device 102 can select a cloud service provider having a service characteristic being closest to the received deployment preference. For instance, computing device 102 can select cloud service provider 104-1 which has a user rating of 4.8 out of 5 (e.g., 4.8 being the closest user rating to the received deployment preference of a 5 out of 5 user rating).

In some examples, computing device 102 can receive a plurality of ranked deployment preferences for the workload, where the plurality of ranked deployment preferences each include a weighted level of importance. As used herein, the term “weighted” refers to a criterion signaling a level of rank to a choice relative to other choices. For example, computing device 102 can receive deployment preferences such as cost to deploy the workload, availability, and service characteristics such as network QOS parameters (e.g., time to access, for example). In some examples, the cost to deploy the workload can be weighted by 0.5, the availability can be weighted by 0.25, and the time to access can be weighted by 0.25.

Computing device 102 can select the cloud service provider according to the ranked and weighted deployment preferences. Computing device 102 can consider the cost to deploy the workload, availability, and time to access of cloud service providers 104. For example, cloud service provider 104-1 can include a deployment cost of $1000, 99.99% availability, and time to access of 25 seconds, cloud service provider 104-2 can include a deployment cost of $1100, 99.9% availability, and time to access of 30 seconds, and cloud service provider can include a deployment cost of $1700, 99.5% availability, and time to access of 45 seconds. Computing device 102 can consider each of the cloud service provider 104-1, 104-2, and 104-3's deployment cost, availability, and time to access, with a higher weight given to the deployment cost considerations of each cloud service provider 104-1, 104-2, and 104-3, and select cloud service provider 104-1 to provide a service for the workload.

In some examples, a user may specify a particular service desired for the workload. For instance, a user may specify Ubuntu to be used for a workload. In such an example, computing device 102 can receive the specified service and select a cloud service provider 104, as is further described herein.

To select a cloud service provider 104, computing device 102 can utilize a service characteristic of the cloud service providers 104. In some examples, computing device 102 can determine the cost of each cloud service provider 104 to provide Ubuntu for the workload and select the cloud service provider 104 having the lowest cost. In some examples, computing device 102 can determine the availability of each cloud service provider 104 to provide Ubuntu for the workload and select the cloud service provider 104 having the highest availability. In some examples, computing device 102 can determine the multiple service characteristics of each cloud service provider 104 to provide Ubuntu for the workload and select the cloud service provider 104 having the best service characteristics with the highest weighting.

Upon selecting the cloud service provider 104, computing device 102 can deploy the workload to the selected cloud service provider. For example, the workload may be a VM. Computing device 102 can select cloud service provider 104-1 to deploy the VM based on a deployment preference for the VM and service characteristics of cloud service provider 104-1, as described above.

Computing device 102 can determine whether the deployed workload on the selected cloud service provider 104 was successful. For example, computing device 102 can receive a deployment preference of 99.5% deployment success rate and select cloud service provider 104-1 to provide a service for the workload as cloud service provider 104-1 can have a 99.5% deployment success rate for VMs. Computing device 102 can determine whether the VM was successfully deployed on the selected cloud service provider 104 (e.g., cloud service provide 104-1).

In an example in which deployment of the workload to cloud service provider 104-1 was unsuccessful, computing device 102 can select a different cloud service provider 104 based on the received deployment preference. For instance, the deployed workload may have failed on cloud service provider 104-1. Computing device 102 can then select a different cloud service provider 104 having a service characteristic that is next closest to the received deployment preference for the workload. For example, in response to the workload failing to deploy on cloud service provider 104-1, computing device 102 can select cloud service provider 104-2 to deploy the workload as cloud service provider 104-2 has a next highest ranked deployment success rate of 99.3%, which is next closest to the receive deployment preference of 99.5%.

In order to select a cloud service provider from a group of cloud service providers according to deployment preferences for a particular workload, computing device 102 can abstract the cloud services provided by cloud service providers 104, as is further described herein.

Computing device 102 can abstract cloud services. Computing device 102 can abstract cloud services according to different methods. As used herein, the term “abstract” can, for example, refer to breaking out into constituent parts services of a cloud service provider. For example, computing device 102 can abstract cloud services by types of services offered, virtual tagging, and/or by cloud service name, as is further described herein.

In some examples, computing device 102 can abstract cloud services by types of services offered. For example, computing device 102 can abstract cloud services offered by cloud service providers 104 based on similar services provided by the different cloud service providers 104. For instance, computing device 102 can abstract cloud service providers 104-1 and 104-2 based on cloud service providers 104-1 and 104-2 each providing particular VM templates, VM orchestration tools, container images and charts, among other types of services offered.

In some examples, computing device 102 can abstract cloud services by virtually tagging types of services offered. As used herein, the term “virtual tag” can, for example, refer to a logical arrangement of keywords in a textual context that describes a particular subject matter. For example, a virtual tag may consistent of keywords describing a particular service of a cloud service provider 104. Computing device 102 can virtually tag various services offered by the cloud service providers 104 and abstract the cloud service providers 104 according to similar virtual tags. For example, computing device 102 can abstract cloud services such as “Ubuntu AWS Image”, “Ubuntu GCP Image”, “Ubuntu Azure Image”, “Ubuntu Vmware Image”, etc.

In some examples, computing device 102 can abstract cloud service providers 104 by name. For example, cloud service provider 104-1 can be abstracted by name (e.g., “Ubuntu”), although examples of the disclosure are not limited to the above cloud services.

Selecting a cloud service provider, according to the disclosure, can allow for a user to specify certain deployment preferences for a particular workload such that a suitable cloud service provider can be automatically selected to deploy the particular workload. The cloud service provider can be selected according to service characteristics of the cloud service provider and the deployment preferences of the user. Accordingly, a user's particular priorities for a workload can be considered in automatically choosing a cloud service provider for the workload. Further, in an event in which the workload fails to deploy, another cloud service provider can automatically be selected, reducing user time and effort in selection of a cloud service provider for a workload.

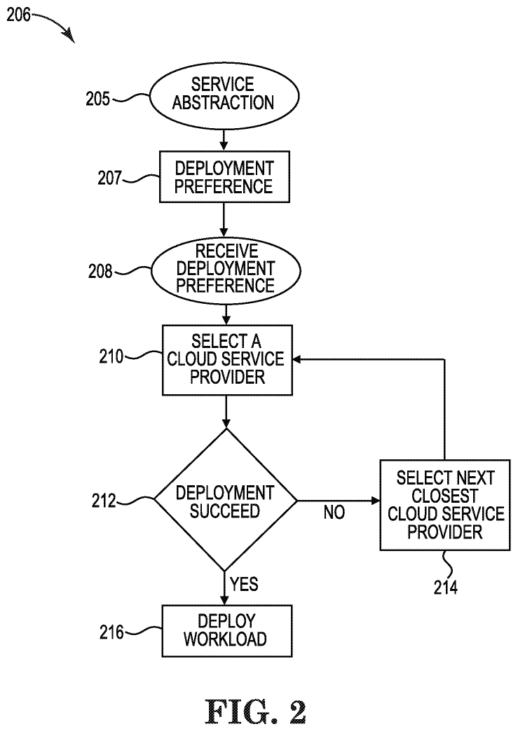

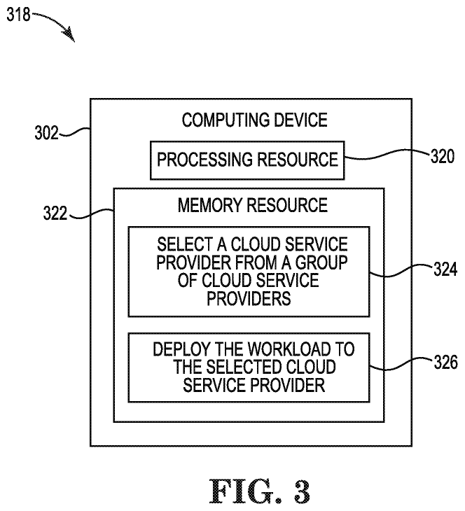

FIG. 2 illustrates an example method 206 consistent with the disclosure. Method 206 may be performed, for example, by a computing device (e.g., computing device 102, previously described in connection with FIG. 1, and computing device 302, as is further described in connection with FIG. 3).

The computing device can, at 205, perform a cloud service abstraction. The computing device can abstract cloud services by, for example, types of services offered, virtual tagging, and/or by cloud service name.

The computing device can, at 207, allow a deployment preference to be selected. The deployment preference can be a prioritized condition of a user for deployment of a workload on a cloud service provider. For example, a workload may be preferred to be deployed according to a success rate of previous workloads deployed on a particular cloud service provider, cost to deploy the workload on a particular cloud service provider, availability of the cloud service provider, network QOS parameters of a particular cloud service provider, user ratings of a particular cloud service provider, and/or cluster orchestration of a particular cloud service provider, among other types of deployment preferences.

The computing device can, at 208, receive a deployment preference. The computing device can select a cloud service provider according to the deployment preference, as is further described herein. In an example in which a deployment preference is not specified, the computing device can select the best cloud service provider according to a filter.

The computing device can, at 210, select a cloud service provider. For example, based on a service characteristic of the selected cloud service provider corresponding to the received deployment preference having a highest rank among service characteristics of the group of cloud service providers, the computing device can select the cloud service provider to provide a service for the workload. Service characteristics of a cloud service provider can correlate with deployment preferences of a user, and can include a success rate of deployment of previous workloads of the cloud service provider, cost to deploy the workload using the cloud service provider, availability of the cloud service provider, network quality of service parameters of the cloud service provider, user ratings of the cloud service provider, and/or cluster orchestration of the cloud service provider, among other service characteristics of a cloud service provider. For example, the computing device can select a cloud service provider according to a service characteristic of the cloud service provider (e.g., a cost to deploy the workload) corresponding to the received deployment preference (e.g., a cost to deploy the workload) being the lowest cost (e.g., highest ranked service characteristic) among the other cloud service providers' costs to deploy the workload.

The computing device can, at 212, determine whether the workload was successfully deployed on the selected cloud service provider. At 216, the workload is deployed successfully. If the workload is not deployed successfully on the selected cloud service provider, the computing device can, at 214, select another cloud service provider having the next closest service characteristic to the received deployment preference. For example, the computing device may select a cloud service provider (e.g., Amazon Web Services (AWS)) to deploy an Ubuntu service. In the event the Ubuntu service fails to deploy on AWS, the computing device can select another cloud service provider (e.g., Google Cloud Platform (GCP)) to deploy the Ubuntu service.

FIG. 3 is a block diagram 318 of an example computing device 302 for selecting a cloud service provider consistent with the disclosure. As described herein, the computing device 302 may perform a number of functions related to selecting a cloud service provider. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and the computing device 302 may be distributed across multiple processors. Put another way, the instructions executed by the computing device 302 may be stored across multiple machine-readable storage mediums and executed across multiple processors, such as in a distributed or virtual computing environment.

As illustrated in FIG. 3, the computing device 302 may comprise a processing resource 320, and a memory resource 322 storing machine-readable instructions to cause the processing resource 320 to perform a number of operations related to selecting a cloud service provider. That is, using the processing resource 320 and the memory resource 322, the computing device 302 may execute a rule to select a cloud service provider, among other operations. Processing resource 320 may be a central processing unit (CPU), microprocessor, and/or other hardware device suitable for retrieval and execution of instructions stored in memory resource 322.

The computing device 302 may include instructions 324 stored in the memory resource 322 and executable by the processing resource 320 to select a cloud service provider from a group of cloud service providers. The cloud service provider can be selected to provide a service for a workload. The cloud service provider can be selected based on a received deployment preference for the workload and a service characteristic of the cloud service provider.

The computing device 302 may include instructions 326 stored in the memory resource 322 and executable by the processing resource 320 to deploy the workload to the selected cloud service provider.

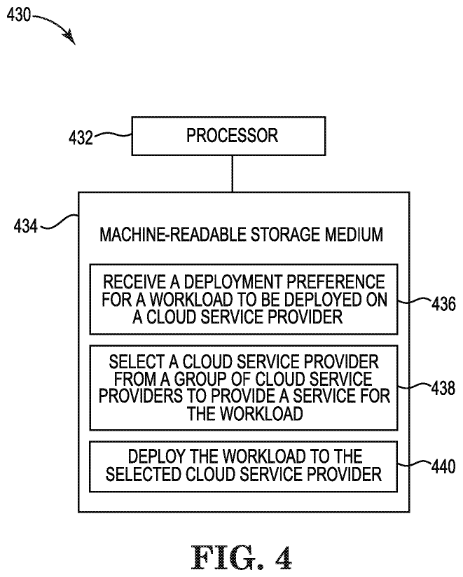

FIG. 4 is a block diagram of an example system 430 consistent with the disclosure. In the example of FIG. 4, system 430 includes a processor 432 and a machine-readable storage medium 434. Although the following descriptions refer to a single processor and a single machine-readable storage medium, the descriptions may also apply to a system with multiple processors and multiple machine-readable storage mediums. In such examples, non-transitory instructions may be distributed across multiple machine-readable storage mediums and the non-transitory instructions may be distributed across multiple processors. Put another way, the non-transitory instructions may be stored across multiple machine-readable storage mediums and executed across multiple processors, such as in a distributed computing environment.

Processor 432 may be a central processing unit (CPU), microprocessor, and/or other hardware device suitable for retrieval and execution of non-transitory instructions stored in machine-readable storage medium 434. In the particular example shown in FIG. 4, processor 432 may receive, determine, and send instructions 436, 438, and 440. As an alternative or in addition to retrieving and executing non-transitory instructions, processor 432 may include an electronic circuit comprising a number of electronic components for performing the operations of the instructions in machine-readable storage medium 434. With respect to the non-transitory executable instruction representations or boxes described and shown herein, it should be understood that part or all of the non-transitory executable instructions and/or electronic circuits included within one box may be included in a different box shown in the figures or in a different box not shown.

Machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. Machine-readable storage medium 434 may be a portable, external or remote storage medium, for example, that allows the system 430 to download the instructions from the portable/external/remote storage medium. In this situation, the executable instructions may be part of an “installation package”. As described herein, machine-readable storage medium 434 may be encoded with executable instructions for selecting a cloud service provider.

Receive instructions 436, when executed by a processor such as processor 432, may cause system 430 to receive a deployment preference for a workload to be deployed on a cloud service provider. Deployment preferences can include a success rate of previous workloads deployed on a particular cloud service provider, cost to deploy the workload on a particular cloud service provider, availability of the cloud service provider, network QOS parameters of a particular cloud service provider, user ratings of a particular cloud service provider, and/or cluster orchestration of a particular cloud service provider, among other types of deployment preferences.

Select instructions 438, when executed by a processor such as processor 432, may cause system 430 to select a cloud service provider from a group of cloud service providers to provide a service for the workload. System 430 can select the cloud service provider based on a service characteristic of the selected cloud service provider corresponding to the received deployment preference having a highest rank among service characteristics of the group of cloud service providers. Service characteristics of a cloud service provider can correlate with deployment preferences of a user, and can include a success rate of deployment of previous workloads of the cloud service provider, cost to deploy the workload using the cloud service provider, availability of the cloud service provider, network quality of service parameters of the cloud service provider, user ratings of the cloud service provider, and/or cluster orchestration of the cloud service provider, among other service characteristics of a cloud service provider.

Deploy instructions 440, when executed by a processor such as processor 432, may cause system 430 to deploy the workload to the selected cloud service provider. In some examples, system 430 can determine whether the workload was deployed successfully. If the workload is not deployed successfully on the selected cloud service provider, system 430 can select another cloud service provider having the next closest service characteristic to the received deployment preference.

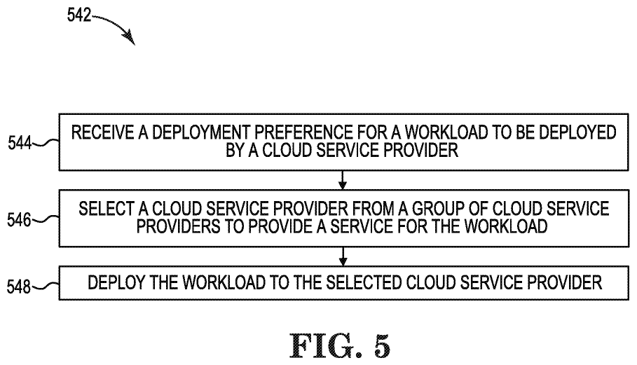

FIG. 5 illustrates an example method 542 consistent with the disclosure. Method 542 may be performed, for example, by a computing device (e.g., computing device 102, 202, 302, previously described in connection with FIGS. 1, 2, and 3, respectively).

At 544, the method 542 may include receiving a deployment preference for a workload to be deployed by a cloud service provider. Deployment preferences can include a success rate of previous workloads deployed on a particular cloud service provider, cost to deploy the workload on a particular cloud service provider, availability of the cloud service provider, network QOS parameters of a particular cloud service provider, user ratings of a particular cloud service provider, and/or cluster orchestration of a particular cloud service provider, among other types of deployment preferences.

At 546, the method 542 may include selecting a cloud service provider from a group of cloud service providers to provide a service for the workload. The computing device can select the cloud service provider based on a service characteristic of the selected cloud service provider corresponding to the received deployment preference having a highest rank among service characteristics of the group of cloud service providers. Service characteristics of a cloud service provider can correlate with deployment preferences of a user, and can include a success rate of deployment of previous workloads of the cloud service provider, cost to deploy the workload using the cloud service provider, availability of the cloud service provider, network quality of service parameters of the cloud service provider, user ratings of the cloud service provider, and/or cluster orchestration of the cloud service provider, among other service characteristics of a cloud service provider.

At 548, the method 542 may include deploying the workload to the selected cloud service provider. In some examples, the computing device can determine whether the workload was deployed successfully. If the workload is not deployed successfully on the selected cloud service provider, the computing device can select another cloud service provider having the next closest service characteristic to the received deployment preference.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
select a cloud service provider from a group of cloud service providers to provide a service for a workload based on:
a received deployment preference for the workload; and
a service characteristic of the cloud service provider; and
deploy the workload to the selected cloud service provider.

2. The computing device of claim 1, including instructions to cause the processing resource to select the cloud service provider based on the service characteristic of the selected cloud service provider corresponding to the received deployment preference having a highest rank among a plurality of service characteristics of the group of cloud service providers.

3. The computing device of claim 1, wherein in response to a received deployment preference for the workload not matching a service characteristic of a cloud service provider of the group of cloud service providers, including instructions to cause the processing resource to select a cloud service provider having a service characteristic being closest to the received deployment preference.

4. The computing device of claim 1, including instructions to cause the processing resource to group the group of cloud service providers.

5. The computing device of claim 1, wherein the service characteristic of the cloud service provider includes at least one of:
a success rate of previous workloads;
cost to deploy the workload;
availability of the cloud service provider;
network quality of service (QOS) parameters;
user ratings of the cloud service provider; and
cluster orchestration of the cloud service provider.

6. The computing device of claim 5, wherein the cost to deploy the workload is based on selected cloud service parameters.

7. The computing device of claim 6, wherein the selected cloud service parameters to deploy the workload include at least one of:
a desired speed of a central processing unit (CPU);
a desired amount of memory;
a desired amount of CPU cores; and
desired hard disk drive (HDD) space.

8. The computing device of claim 1, including instructions to cause the processing resource to determine whether the deployed workload on the selected cloud service provider was successful.

9. The computing device of claim 8, including instructions to cause the processing resource to:
select, in response to the deployed workload failing on the selected cloud service provider, a different cloud service provider from the group of cloud service providers based on the received deployment preference; and
deploy the workload to the different cloud service provider;
wherein the different cloud service provider is selected based on the different cloud service provider having a service characteristic that is next closest to the received deployment preference for the workload.

10. The computing device of claim 1, wherein the group of cloud service providers include at least one of public cloud service providers and private cloud service providers.

11. The computing device of claim 1, wherein the services of the cloud service providers include at least one of:
virtual machine (VM) images;
container images and charts; and
VM templates.

12. A non-transitory computer readable medium storing instructions executable by a processing resource to cause the processing resource to:
receive a deployment preference for a workload to be deployed by a cloud service provider;
select a cloud service provider from a group of cloud service providers to provide a service for the workload based on a service characteristic of the selected cloud service provider corresponding to the received deployment preference having a highest rank among service characteristics of the group of cloud service providers; and
deploy the workload to the selected cloud service provider.

13. The medium of claim 12, comprising instructions to abstract the group of cloud service providers based on types of services offered by the group of cloud service providers.

14. The medium of claim 12, comprising instructions to abstract the group of cloud service providers by virtually tagging similar services of the group of cloud service providers.

15. The medium of claim 12, comprising instructions to abstract the group of cloud service providers by names of each of the cloud service providers.

16. A method, comprising:
receiving, by a computing device, a deployment preference for a workload to be deployed by a cloud service provider;
selecting, by a computing device, a cloud service provider from a group of cloud service providers to provide a service for the workload based on a service characteristic of the selected cloud service provider corresponding to the received deployment preference having a highest rank among service characteristics of the group of cloud service providers; and
deploying, by the computing device, the workload to the selected cloud service provider.

17. The method of claim 16, wherein the method includes grouping the cloud service providers based on types of services offered by the group of cloud services.

18. The method of claim 17, wherein the method further includes selecting the cloud service provider based on the cloud service provider offering the service for the workload.

19. The method of claim 16, wherein the method includes receiving a plurality of ranked deployment preferences for the workload, wherein the plurality of ranked deployment preferences each include a weighted level of importance.

20. The method of claim 19, wherein the method includes selecting the cloud service provider according to the ranked and weighted deployment preferences.
